(19) United States
(12) Patent Application Publication
(10) Pub. No.: US 2010/0008607 A1
(43) Pub. Date: Jan. 14, 2010

(54) SLIDE MECHANISM FOR PORTABLE ELECTRONIC DEVICE

(75) Inventors: XIN-FENG LIAO, Shenzhen City (CN); YUNG-CHANG YEN, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/497,743

(22) Filed: Jul. 6, 2009

(30) Foreign Application Priority Data
Jul. 11, 2008 (CN) 200810302700.0

(51) Int. Cl. F16C 29/02

(52) U.S. Cl. 384/26

(57) ABSTRACT

A slide mechanism includes a first plate and a second plate. The second plate includes a second main body, and two slide rails positioned on two end of the second main body. Each of the slide rails includes a rail portion and an embedded portion moldingly formed in the rail portion. The first plate is installed in the slide rails and slidable relative to the second plate. The invention also discloses a portable electronic device using the slide mechanism.

### BACKGROUND

1. Technical Field

The present disclosure relates to portable electronic devices, and particularly, to a sliding mechanism used in a portable electronic device.

2. Description of Related Art

Slide-type portable electronic devices have become increasingly popular. A typical slide-type portable electronic device usually has two housings. One of the housings slides over the other housing, thereby opening/closing the portable electronic device by a slide mechanism.

A typical slide mechanism includes a first slide plate and a second slide plate slidably assembled on the first slide plate. The first slide plate includes two slots and two guiding rails. The slots are defined in the first slide plate. The guiding rails are respectively secured in the slots. The second slide plate is engagable in the guiding rails, and configured for sliding on the first slide plate. However, the guiding rails are usually thick in size, thus occupy a large amount of space of the portable electronic device. Such slide mechanism does not satisfy requirements in miniaturization of the portable electronic device. Furthermore, the guiding rails are secured on the first slide plate by assembly process, thereby reducing production efficiency.

Therefore, there is room for improvement within the art.

### BRIEF DESCRIPTION OF THE DRAWINGS

Many aspects of a sliding mechanism used in a portable electronic device can be better understood with reference to the following drawings. The components in the drawings are not necessarily to scale, the emphasis instead being placed upon clearly illustrating the principles of the present sliding mechanism used in a portable electronic device. Moreover, in the drawings, like reference numerals designate corresponding parts throughout the several views:

FIG. 1 is a schematic assembled view of an exemplary embodiment of a slide mechanism.

FIG. 2 is a schematic exploded view of the slide mechanism shown in FIG. 1.

FIG. 3 is a cross-sectional view taken along line III-III of FIG. 1.

FIG. 4 is a schematic assembled view of a portable electronic device.

### DETAILED DESCRIPTION OF EMBODIMENTS

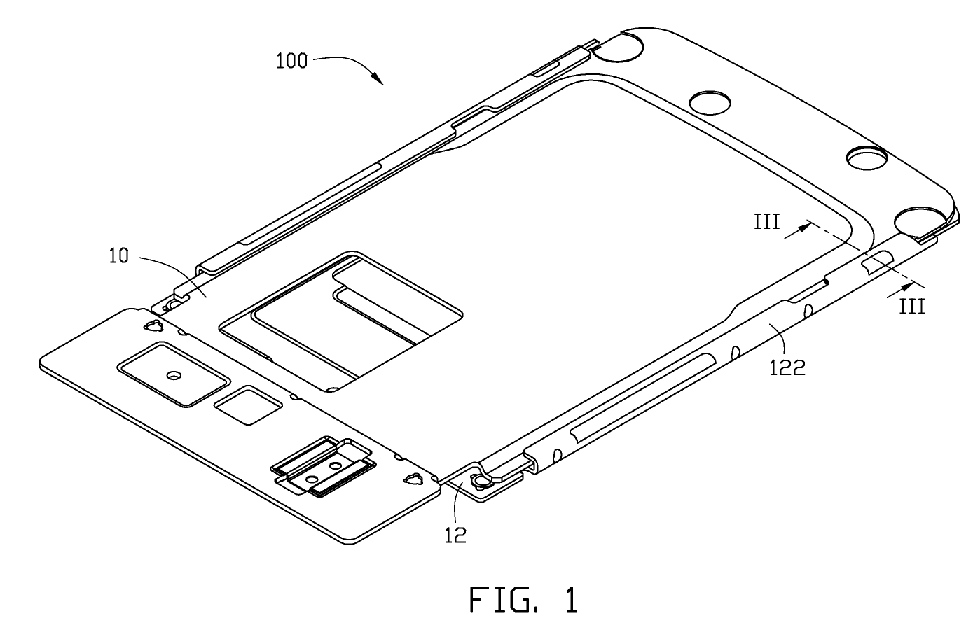

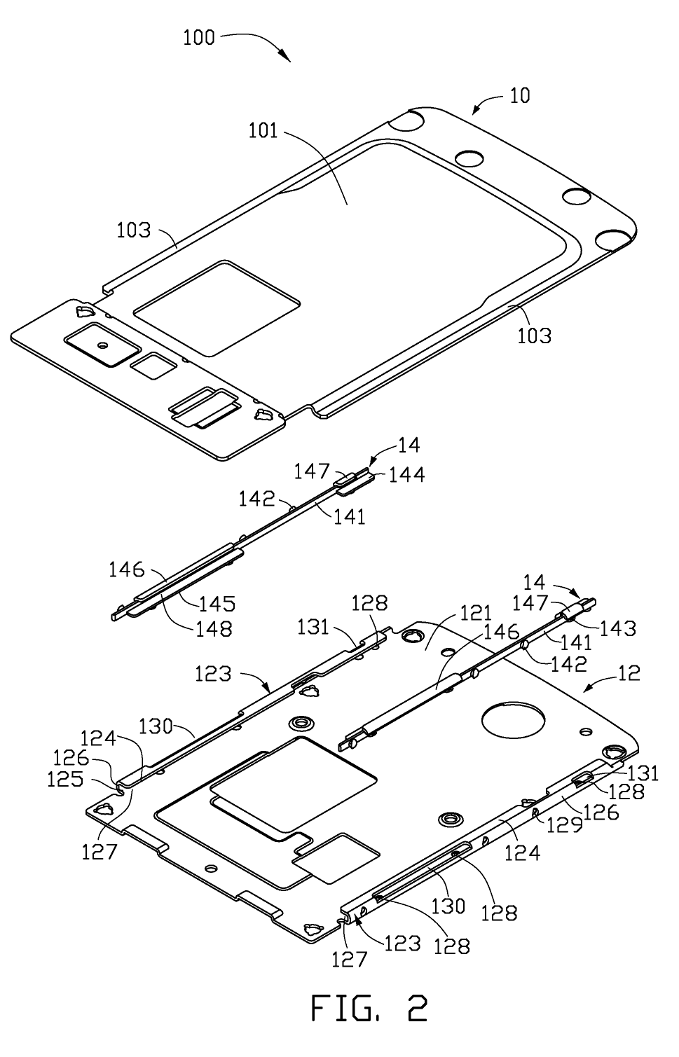

FIGS. 1 and 2 show an exemplary embodiment of a slide mechanism 100. The slide mechanism 100 includes a first plate 10 and a second plate 12 that can slide relative to the first plate 10.

The first plate 10 can be made of metal, and include a first main body 101 and two sliding portions 103 respectively positioned on two ends of the first main body 101. The sliding portions 103 are integrally formed with the first main body 101.

The second plate 12 can be made of metal, and include a second main body 121 and two slide rails 122 symmetrically positioned on two ends of the second main body 121.

Each of the slide rails 122 includes a rail portion 123 and an embedded portion 14. The rail portion 123 is U-shaped, and includes a first wall 124, a second wall 125 parallel to the first wall 124, and a sidewall 126 connecting the first wall 124 and the second wall 125. The first wall 124, the second wall 125 and the sidewall 126 cooperatively enclose a guide slot 127. The second wall 125 connects to the second main body 121, and defines a plurality of first through holes 128 therein. The sidewall 126 defines a plurality of second through holes 129 therein. The sidewall 126 and the first wall 124 have a joint section defining a first opening 130 and a second opening 131. The first opening 130 and the second opening 131 are spaced from each other. The first through holes 128 are exposed from the first opening 130 and the second opening 131. The rail portion 123 is integrally formed with the second main body 121.

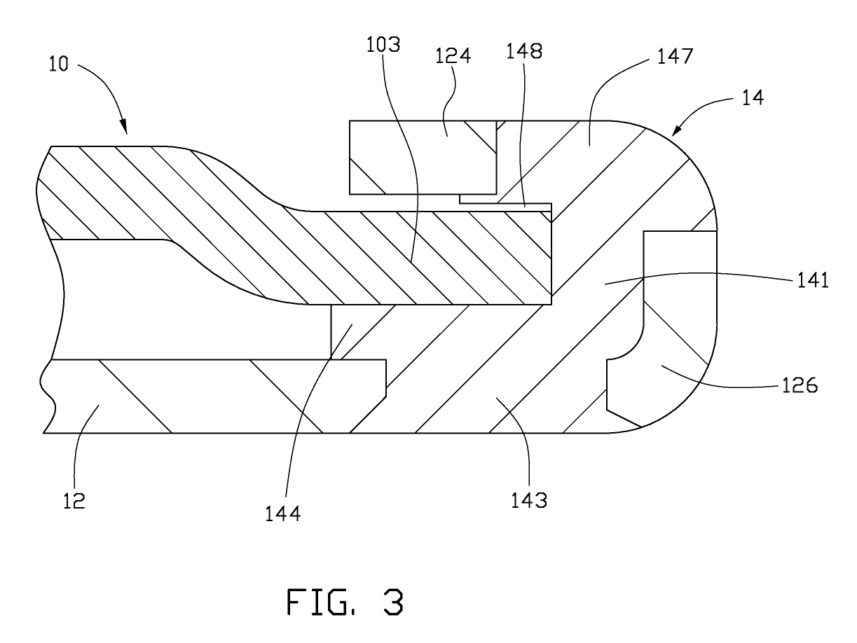

Referring to FIG. 3, the embedded portion 14 can be made of plastic, and includes a main wall 141, a plurality of first posts 142 corresponding to the second through holes 129, a plurality of second posts 143 corresponding to the first through holes 128, a first slide portion 144, a second slide portion 145, a first connect wall 146 corresponding to the first opening 130, and a second connect wall 147 corresponding to the second opening 131. The main wall 141 is secured in the guide slot 127. The first posts 142 are positioned on a side of the main wall 141. The first slide portion 144 and the second slide portion 145 are positioned on an opposite side of the main wall 141 to the first posts 142. The second posts 143 are positioned on a same side of main wall 141 as the first slide portion 144 and the second slide portion 145. The first connect wall 146 and the second connect wall 147 are positioned on an opposite side of main wall 141 to the second posts 143. The first connect wall 146 and the second connect wall 147 are spaced from each other corresponding to the first opening 130 and the second opening 131. The embedded portion 14 is directly bonded to the rail portion 123 by injection molding. The main wall 141 is received in the guide slot 127. The first slide portion 144 and the second slide portion 145 are moldingly secured on the second wall 125. The first posts 142 are moldingly secured in the second through holes 129, configured for increasing bonding force between the sidewall 126 and the embedded portion 14. The second posts 143 are moldingly secured in the first through holes 128, configured for increasing bonding force between the second wall 125 and the embedded portion 14. The first connect wall 146 and the second connect wall 147 moldingly engage in the first opening 130 and the second opening 131, configured for increasing bonding force between the rail portion 123 and the embedded portion 14. The first slide portion 144 and the first connect wall 146 define a slide slot 148 therebetween. The second slide portion 145 and the second connect wall 147 also define the slide slot 148 therebetween. The sliding portions 103 can slide in the slide slot 148, thereby the first plate 10 can slide relative to the second plate 12.

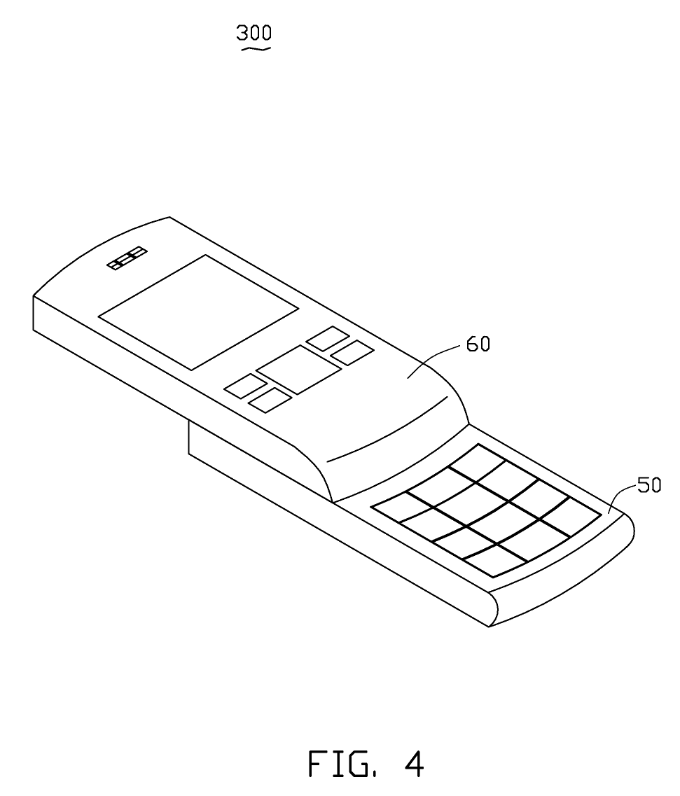

Referring to the FIG. 4, the slide mechanism 100 can be used in a portable electronic device 300. The portable electronic device 300 includes a main cover 50 and a slide cover 60 slidably assembled on the main cover 50. The first main body 101 is secured on the slide cover 60, and the second main body 121 is secured on the main cover 50. When the first plate 10 is assembled on the second plate 12 as above assembly method, the slide cover 60 is slidable on the main cover 50.

Each embedded portion 14 is directly moldingly secured in the corresponding rail portion 123 to form the slide rails 122. The main wall 141, the first slide portion 144 and the second slide portion 145 can be made smaller. Such slide mechanism 100 can satisfy requirements in miniaturization of the portable electronic device. Furthermore, the embedded portion 14 is directly moldingly bond to the rail portion 123 by injection molding, thereby increasing production efficiency.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A slide mechanism, comprising:
a first plate;
a second plate comprising a second main body, and two slide rails positioned on two ends of the second main body;
each of the slide rails comprising a rail portion and an embedded portion moldingly formed in the rail portion;
wherein the first plate is installed in the slide rails and slidable relative to the second plate.

2. The slide mechanism as claimed in claim 1, wherein each rail portion comprises two walls and a sidewall cooperatively enclosing a guide slot, each embedded portion is moldingly formed in the guide slot.

3. The slide mechanism as claimed in claim 2, wherein each wall defines a plurality of first through holes, each embedded portion comprises a main wall and a plurality of first posts positioned on the main wall, the first posts are moldingly secured in respective first through holes for securing the main wall to each sidewall.

4. The slide mechanism as claimed in claim 3, wherein each sidewall defines a plurality of second through holes, each embedded portion further comprises a two slide portions positioned on an opposite side of main wall to the first posts, a plurality of second posts positioned on each of the slide portions, the second posts are moldingly secured in respective second through holes for securing the slide portions to the walls.

5. The slide mechanism as claimed in claim 3, wherein each sidewall and the wall define a first opening and a second opening, each embedded portion further comprises two connect walls moldingly engage in the first opening and the second opening, respectively.

6. The slide mechanism as claimed in claim 1, wherein the first plate comprises a first main body and two sliding portions respectively positioned on two sides of the first main body, the sliding portions are slidable in the slide rails.

7. The slide mechanism as claimed in claim 6, wherein the first plate is made of metal, the sliding portions are integrally formed with the first main body.

8. The slide mechanism as claimed in claim 1, wherein each embedded portion is made of plastic.

9. The slide mechanism as claimed in claim 1, wherein the second plate is made of metal, each rail portion is integrally formed with the second main body.

10. A portable electronic device, comprising:
a main cover;
a slide cover slidably assembled on the main cover;
a slide mechanism, comprising:
a first plate secured on the slide cover;
a second plate secured on the main cover, and comprising a second main body, and two slide rails positioned on two ends of the second main body;
each of the slide rails comprising a rail portion and an embedded portion moldingly formed in the rail portion;
wherein the first plate is installed in the slide rails and slidable relative to the second plate, configured for opening or closing the portable electronic device.

11. The portable electronic device as claimed in claim 10, wherein each rail portion comprises two walls and a sidewall cooperatively enclosing a guide slot, each embedded portion is moldingly formed in the guide slot.

12. The portable electronic device as claimed in claim 11, wherein each wall defines a plurality of first through holes, each embedded portion comprises a main wall and a plurality of first posts positioned on the main wall, the first posts are moldingly secured in respective first through holes for securing the main wall to each sidewall.

13. The portable electronic device as claimed in claim 12, wherein each sidewall defines a plurality of second through holes, each embedded portion further comprises a two slide portions positioned on an opposite side of main wall to the first posts, a plurality of second posts positioned on the slide portions, the second posts are moldingly secured in respective second through holes for securing the slide portions to the walls.

14. The portable electronic device as claimed in claim 12, wherein each sidewall and the wall define a first opening and a second opening, each embedded portion further comprises two connect walls moldingly engage in the first opening and the second opening, respectively.

15. The portable electronic device as claimed in claim 11, wherein the first plate comprises a first main body and two sliding portions respectively positioned on two sides of the first main body, the sliding portions are slidable in the slide rails.

16. The portable electronic device as claimed in claim 15, wherein the first plate is made of metal, the sliding portions are integrally formed with the first main body.

17. The portable electronic device as claimed in claim 11, wherein each embedded portion is made of plastic.

18. The portable electronic device as claimed in claim 11, wherein the second plate is made of metal, each rail portion is integrally formed with the second main body.
